(19) United States
(12) Patent Application Publication
(10) Pub. No.: US 2026/0234057 A1
(43) Pub. Date: Aug. 13, 2026

(54) FORMULATIONS AND METHODS FOR EXTRUDED FIBER CEMENT PRODUCTS

(71) Applicant: JAMES HARDIE TECHNOLOGY LIMITED, Dublin 2 (IE)

(72) Inventors: Huagang ZHANG, Rancho Cucamonga, CA (US); Xiangyuan LIU, Rancho Cucamonga, CA (US); Yan LI, Rancho Cucamonga, CA (US); Jing NA, Rancho Cucamonga, CA (US); Jongmin KEUM, Rancho Cucamonga, CA (US); Abdul Salam MOHAMMAD, Rancho Cucamonga, CA (US); Daniel KURUVILLA, Rancho Cucamonga, CA (US); Thinh PHAM, Yucaipa, CA (US)

(21) Appl. No.: 19/475,263

(22) PCT Filed: Apr. 18, 2024
(86) PCT No.: PCT/US2024/025291

§ 371 Date: Oct. 14, 2025

Related U.S. Application Data
(60) Provisional application No. 63/497,576, filed on Apr. 21, 2023.

(51) Int. Cl. C04B 28/10; C04B 20/00; C04B 40/02; C04B 103/30; C04B 103/44; C04B 111/00

(52) U.S. Cl. CPC C04B 28/10; C04B 20/0048; C04B 40/02; C04B 2103/304; C04B 2103/44; C04B 2111/00129

(57) ABSTRACT

Fiber cement composite formulations are provided herein for manufacturing fiber cement building articles via an extruder. Some embodiments include: a cementitious binder having a particle size distribution between 1 μm and 150 μm and including cement and at least 5% by dry weight of limestone; cellulose and polypropylene fibers; a first quantity of silica having a particle size distribution between 1 μm and 250 μm; microparticulate cured fiber cement material having a particle size distribution between 1 μm and 600 μm and comprising a second quantity of silica of the fiber cement composite formulation; a viscosity-enhancing admixture; and an air-entraining admixture. A total amount of silica in the formulation can include the first and second quantities of silica. In some embodiments, a ratio of the cement to the total amount of silica in the formulation is between 0.7 and 1.5.

### CROSS-REFERENCE TO RELATED APPLICATIONS

This application is the U.S. National Phase of PCT/US2024/025291, filed on Apr. 18, 2024, entitled “FORMULATIONS AND METHODS FOR EXTRUDED FIBER CEMENT PRODUCTS,” which claims the benefit of U.S. Provisional Application Serial No. 63/497576, filed Apr. 21, 2023, entitled “FORMULATIONS AND METHODS FOR EXTRUDED FIBER CEMENT PRODUCTS,” each of which is hereby incorporated by reference in its entirety and for all purposes.

### FIELD

The present disclosure generally relates to fiber cement composite formulations, fiber cement products, and methods of making the same.

### BACKGROUND

Fiber cement formulations are frequently used to form exterior and/or interior surfaces of a building structure. Fiber cement-based cladding and interior boards have become popular alternatives to traditional materials in both residential and commercial construction. In addition to fibers and other components, fiber cement formulations generally include a cementitious binder. The manufacture of conventional cementitious binders utilized in existing fiber cement formulations (such as Type 1 Portland cement) generates a large carbon footprint due in part to the emissions arising from cement clinker production.

### SUMMARY

The present disclosure provides fiber cement composite formulations that have a significantly reduced carbon footprint in comparison to existing fiber cement formulations. Various embodiments of the disclosed fiber cement composite formulations include cementitious binders having a notable percentage of limestone, which replaces the amount of cement clinker that is needed. In various embodiments, the disclosed cementitious binders are combined with synergistic combinations of silica and fibers (such as cellulose and polypropylene fibers), which yield unexpectedly high strength, durability, and dimensional stability characteristics in cured fiber cement products. Various embodiments also include microparticulate cured fiber cement material, which accelerates initial hydration of the fiber cement composite formulation prior to final curing and further contributes to such desirable performance characteristics in the cured fiber cement products. The disclosed fiber cement composite formulations have been found to be particularly suitable for manufacturing fiber cement building products via an extrusion process, which provides an alternative to the more traditional technique utilizing the Hatschek process.

Disclosed herein is a fiber cement composite formulation comprising: between 30% and 60% by dry weight of a cementitious binder having a particle size distribution between 1 μm and 150 μm, the cementitious binder comprising cement and at least 5% by dry weight of limestone; a first quantity of silica having a particle size distribution between 1 μm and 250 μm; between 5% and 30% by dry weight of microparticulate cured fiber cement material having a particle size distribution between 1 μm and 600 μm, said microparticulate cured fiber cement material comprising a second quantity of silica, wherein a total amount of silica in the fiber cement composite formulation that includes the first and second quantities of silica comprises between 20% and 50% of the dry weight of the fiber cement composite formulation, and wherein a ratio of the cement to the total amount of silica in the fiber cement composite formulation is between 0.7 and 1.5; between 0.5% and 10% by dry weight of cellulose fibers; between 0.2% and 4% by dry weight of polypropylene fibers; a viscosity-enhancing admixture; and an air-entraining admixture.

In some embodiments, the fiber cement composite formulation comprises between 35% and 50% by dry weight of the cementitious binder. In some embodiments, the cementitious binder comprises between 5% and 20% by dry weight of limestone. In some embodiments, the total amount of silica in the fiber cement composite formulation comprises between 30% and 45% of the dry weight of the fiber cement composite formulation.

In some embodiments, the fiber cement composite formulation comprises between 3% and 5% by dry weight of the cellulose fibers. In some embodiments, the fiber cement composite formulation comprises between 0.5% and 2% by dry weight of the polypropylene fibers. In some embodiments, the fiber cement composite formulation comprises between 5% and 15% by dry weight of the microparticulate cured fiber cement material. In some embodiments, the fiber cement composite formulation comprises between 15% and 25% by dry weight of the microparticulate cured fiber cement material. In some embodiments, the fiber cement composite formulation comprises between 20% and 25% by dry weight of the microparticulate cured fiber cement material.

In some embodiments, the fiber cement composite formulation comprises between 0.5% and 2% by dry weight of the viscosity-enhancing admixture. In some embodiments, the viscosity-enhancing admixture comprises at least one of hydroxyethyl methyl cellulose, hydroxypropyl methyl cellulose, and hydroxyethyl cellulose. In some embodiments, said viscosity-enhancing admixture comprises a viscosity between 1,000 mPa·s and 100,000 mPa·s in a 2% water solution. In some embodiments, said viscosity is between 50,000 mPa·s and 100,000 mPa·s in the 2% water solution. In some embodiments, the fiber cement composite formulation comprises between 0.01% and 0.5% by dry weight of the air-entraining admixture. In some embodiments, the fiber cement composite formulation comprises between 0.03% and 0.07% by dry weight of the air-entraining admixture.

In some embodiments, the first quantity of silica has a mean particle size that is between 10 μm and 40 μm. In some embodiments, the cementitious binder has a mean particle size that is between 10 μm and 30 μm. In some embodiments, the second quantity of silica comprises between 15% and 25% of the dry weight of said microparticulate cured fiber cement material. In some embodiments, the ratio of the cement to the total amount of silica in the fiber cement composite formulation is between 0.9 and 1.3.

Disclosed herein is a method of manufacturing a fiber cement building article, the method comprising: forming the fiber cement building article from a fiber cement composite formulation using an extruder; and curing the fiber cement building article. The fiber cement composite formulation can be any of those disclosed herein. In some embodiments, the fiber cement composite formulation comprises: between 30% and 60% by dry weight of a cementitious binder having a particle size distribution between 1 μm and 150 μm, the cementitious binder comprising cement and at least 5% by dry weight of limestone; a first quantity of silica having a particle size distribution between 1 μm and 250 μm; between 5% and 30% by dry weight of microparticulate cured fiber cement material having a particle size distribution between 1 μm and 600 μm, said microparticulate cured fiber cement material comprising a second quantity of silica, wherein a total amount of silica in the fiber cement composite formulation that includes the first and second quantities of silica comprises between 20% and 50% of the dry weight of the fiber cement composite formulation, and wherein a ratio of the cement to the total amount of silica in the fiber cement composite formulation is between 0.7 and 1.5; between 0.5% and 10% by dry weight of cellulose fibers; between 0.2% and 4% by dry weight of polypropylene fibers; a viscosity-enhancing admixture; and an air-entraining admixture.

In some embodiments, said curing comprises autoclave curing the fiber cement building article in an autoclave. In some embodiments, said curing comprises autoclave curing the fiber cement building article in said autoclave at a temperature of between 150° C. and 160° C. In some embodiments, said curing comprises autoclave curing the fiber cement building article in said autoclave for a time period between 8 hours and 16 hours. In some embodiments, said curing comprises: precuring the fiber cement building article at a first temperature; and after said precuring, autoclave curing the fiber cement building article at a second temperature that is greater than said first temperature.

In some embodiments, the fiber cement composite formulation comprises between 35% and 50% by dry weight of the cementitious binder. In some embodiments, the cementitious binder comprises between 5% and 20% by dry weight of limestone. In some embodiments, the total amount of silica in the fiber cement composite formulation comprises between 30% and 45% of the dry weight of the fiber cement composite formulation. In some embodiments, the fiber cement composite formulation comprises between 5% and 15% by dry weight of the microparticulate cured fiber cement material.

In some embodiments, the fiber cement composite formulation comprises between 15% and 25% by dry weight of the microparticulate cured fiber cement material. In some embodiments, the fiber cement composite formulation comprises between 20% and 25% by dry weight of the microparticulate cured fiber cement material.

In some embodiments, the fiber cement composite formulation comprises between 0.5% and 2% by dry weight of the viscosity-enhancing admixture. In some embodiments, the viscosity-enhancing admixture comprises at least one of hydroxyethyl methyl cellulose, hydroxypropyl methyl cellulose, and hydroxyethyl cellulose. In some embodiments, the fiber cement composite formulation comprises between 0.01% and 0.5% by dry weight of the air-entraining admixture. In some embodiments, the ratio of the cement to the total amount of silica in the fiber cement composite formulation is between 0.9 and 1.3. In some embodiments, the fiber cement composite formulation comprises between 3% and 5% by dry weight of the cellulose fibers. In some embodiments, the fiber cement composite formulation comprises between 0.5% and 2% by dry weight of the polypropylene fibers.

Disclosed herein is a fiber cement composite formulation comprising: between 30% and 60% by dry weight of a cementitious binder having a particle size distribution between 1 μm and 150 μm, the cementitious binder comprising cement and at least 5% by dry weight of limestone; between 20% and 50% by dry weight of silica, wherein a ratio of the cement to the silica in the fiber cement composite formulation is between 0.7 and 1.5; between 0.5% and 10% by dry weight of cellulose fibers; and between 0.2% and 4% by dry weight of polypropylene fibers. In some embodiments, the fiber cement composite formulation comprises between 35% and 50% by dry weight of the cementitious binder. In some embodiments, the cementitious binder comprises between 5% and 20% by dry weight of limestone.

In some embodiments, the fiber cement composite formulation further comprises a viscosity-enhancing admixture. In some embodiments, the fiber cement composite formulation comprises between 0.5% and 2% by dry weight of the viscosity-enhancing admixture. In some embodiments, the viscosity-enhancing admixture comprises at least one of hydroxyethyl methyl cellulose, hydroxypropyl methyl cellulose, and hydroxyethyl cellulose. In some embodiments, said viscosity-enhancing admixture comprises a viscosity between 1,000 mPa·s and 100,000 mPa·s in a 2% water solution. In some embodiments, said viscosity is between 50,000 mPa·s and 100,000 mPa·s in the 2% water solution. In some embodiments, the fiber cement composite formulation further comprises an air-entraining admixture. In some embodiments, the fiber cement composite formulation comprises between 0.01% and 0.5% by dry weight of the air-entraining admixture. In some embodiments, the fiber cement composite formulation comprises between 0.03% and 0.07% by dry weight of the air-entraining admixture.

In some embodiments, the ratio of the cement to the silica in the fiber cement composite formulation is between 0.9 and 1.3. In some embodiments, the fiber cement composite formulation comprises between 3% and 5% by dry weight of the cellulose fibers. In some embodiments, the fiber cement composite formulation comprises between 0.5% and 2% by dry weight of the polypropylene fibers. In some embodiments, the fiber cement composite formulation further comprises between 5% and 30% by dry weight of microparticulate cured fiber cement material.

Disclosed herein is a fiber cement composite formulation comprising: between 30% and 60% by dry weight of a cementitious binder having a particle size distribution between 1 μm and 150 μm, the cementitious binder comprising limestone and; a first quantity of silica having a particle size distribution between 1 μm and 250 μm; between 5% and 30% by dry weight of microparticulate cured fiber cement material having a particle size distribution between 1 μm and 600 μm, said microparticulate cured fiber cement material comprising a second quantity of silica, wherein a total amount of silica in the fiber cement composite formulation that includes the first and second quantities of silica comprises between 20% and 50% of the dry weight of the fiber cement composite formulation, and wherein a ratio of the cementitious binder to the total amount of silica in the fiber cement composite formulation is between 0.7 and 1.7; between 0.5% and 10% by dry weight of cellulose fibers; between 0.2% and 4% by dry weight of polypropylene fibers; a viscosity-enhancing admixture; and an air-entraining admixture. In some embodiments, the cementitious binder comprises at least 1% by dry weight of limestone. In some embodiments, the cementitious binder comprises at least 2% by dry weight of limestone. In some embodiments, the cementitious binder comprises at least 5% by dry weight of limestone. In some embodiments, the ratio of the cementitious binder to the total amount of silica in the fiber cement composite formulation is between 0.8 and 1.5.

In some embodiments, the fiber cement composite formulation comprises between 35% and 50% by dry weight of the cementitious binder. In some embodiments, the cementitious binder comprises between 5% and 20% by dry weight of limestone. In some embodiments, the total amount of silica in the fiber cement composite formulation comprises between 30% and 45% of the dry weight of the fiber cement composite formulation. In some embodiments, the fiber cement composite formulation comprises between 3% and 5% by dry weight of the cellulose fibers. In some embodiments, the fiber cement composite formulation comprises between 0.5% and 2% by dry weight of the polypropylene fibers. In some embodiments, wherein the fiber cement composite formulation comprises between 5% and 15% by dry weight of the microparticulate cured fiber cement material. In some embodiments, wherein the fiber cement composite formulation comprises between 15% and 25% by dry weight of the microparticulate cured fiber cement material. In some embodiments, the fiber cement composite formulation comprises between 20% and 25% by dry weight of the microparticulate cured fiber cement material.

In some embodiments, the fiber cement composite formulation comprises between 0.5% and 2% by dry weight of the viscosity-enhancing admixture. In some embodiments, the viscosity-enhancing admixture comprises at least one of hydroxyethyl methyl cellulose, hydroxypropyl methyl cellulose, and hydroxyethyl cellulose. In some embodiments, said viscosity-enhancing admixture comprises a viscosity between 1,000 mPa·s and 100,000 mPa·s in a 2% water solution. In some embodiments, said viscosity is between 50,000 mPa's and 100,000 mPa's in the 2% water solution. In some embodiments, the fiber cement composite formulation comprises between 0.01% and 0.5% by dry weight of the air-entraining admixture. In some embodiments, the fiber cement composite formulation comprises between 0.03% and 0.07% by dry weight of the air-entraining admixture.

In some embodiments, the first quantity of silica has a mean particle size that is between 10 μm and 40 μm. In some embodiments, the cementitious binder has a mean particle size that is between 10 μm and 30 μm. In some embodiments, the second quantity of silica comprises between 15% and 25% of the dry weight of said microparticulate cured fiber cement material. In some embodiments, the ratio of the cementitious binder to the total amount of silica in the fiber cement composite formulation is between 1 and 1.4.

Disclosed herein is a method of manufacturing a fiber cement building article, the method comprising: forming the fiber cement building article from a fiber cement composite formulation using an extruder; and curing the fiber cement building article. The fiber cement composite formulation can be any of those disclosed herein. In some embodiments, the fiber cement composite formulation comprises: between 30% and 60% by dry weight of a cementitious binder having a particle size distribution between 1 μm and 150 μm, the cementitious binder comprising limestone; a first quantity of silica having a particle size distribution between 1 μm and 250 μm; between 5% and 30% by dry weight of microparticulate cured fiber cement material having a particle size distribution between 1 μm and 600 μm, said microparticulate cured fiber cement material comprising a second quantity of silica, wherein a total amount of silica in the fiber cement composite formulation that includes the first and second quantities of silica comprises between 20% and 50% of the dry weight of the fiber cement composite formulation, and wherein a ratio of the cementitious binder to the total amount of silica in the fiber cement composite formulation is between 0.7 and 1.7; between 0.5% and 10% by dry weight of cellulose fibers; between 0.2% and 4% by dry weight of polypropylene fibers; a viscosity-enhancing admixture; and an air-entraining admixture. In some embodiments, the cementitious binder comprises at least 1% by dry weight of limestone. In some embodiments, the cementitious binder comprises at least 2% by dry weight of limestone. In some embodiments, the cementitious binder comprises at least 5% by dry weight of limestone. In some embodiments, the ratio of the cementitious binder to the total amount of silica in the fiber cement composite formulation is between 0.8 and 1.5.

In some embodiments, said curing comprises autoclave curing the fiber cement building article in an autoclave. In some embodiments, said curing comprises autoclave curing the fiber cement building article in said autoclave at a temperature of between 150° C. and 160° C. In some embodiments, said curing comprises autoclave curing the fiber cement building article in said autoclave for a time period between 6 hours and 16 hours (for example, between 8 hours and 10 hours). In some embodiments, said curing comprises: precuring the fiber cement building article at a first temperature; and after said precuring, autoclave curing the fiber cement building article at a second temperature that is greater than said first temperature. In some embodiments, the fiber cement composite formulation comprises between 35% and 50% by dry weight of the cementitious binder. In some embodiments, the cementitious binder comprises between 5% and 20% by dry weight of limestone. In some embodiments, the total amount of silica in the fiber cement composite formulation comprises between 30% and 45% of the dry weight of the fiber cement composite formulation. In some embodiments, the fiber cement composite formulation comprises between 5% and 15% by dry weight of the microparticulate cured fiber cement material. In some embodiments, the fiber cement composite formulation comprises between 15% and 25% by dry weight of the microparticulate cured fiber cement material. In some embodiments, the fiber cement composite formulation comprises between 20% and 25% by dry weight of the microparticulate cured fiber cement material. In some embodiments, the fiber cement composite formulation comprises between 0.5% and 2% by dry weight of the viscosity-enhancing admixture. In some embodiments, the viscosity-enhancing admixture comprises at least one of hydroxyethyl methyl cellulose, hydroxypropyl methyl cellulose, and hydroxyethyl cellulose. In some embodiments, the fiber cement composite formulation comprises between 0.01% and 0.5% by dry weight of the air-entraining admixture. In some embodiments, the ratio of the cementitious binder to the total amount of silica in the fiber cement composite formulation is between 1 and 1.4. In some embodiments, the fiber cement composite formulation comprises between 3% and 5% by dry weight of the cellulose fibers. In some embodiments, the fiber cement composite formulation comprises between 0.5% and 2% by dry weight of the polypropylene fibers.

Disclosed herein is a fiber cement composite formulation comprising: between 30% and 60% by dry weight of a cementitious binder having a particle size distribution between 1 μm and 150 μm, the cementitious binder comprising limestone; between 20% and 50% by dry weight of silica, wherein a ratio of the cementitious binder to the silica in the fiber cement composite formulation is between 0.7 and 1.7; between 0.5% and 10% by dry weight of cellulose fibers; and between 0.2% and 4% by dry weight of polypropylene fibers. In some embodiments, the cementitious binder comprises at least 1% by dry weight of limestone. In some embodiments, the cementitious binder comprises at least 2% by dry weight of limestone. In some embodiments, the cementitious binder comprises at least 5% by dry weight of limestone. In some embodiments, the ratio of the cementitious binder to the silica in the fiber cement composite formulation is between 0.8 and 1.5.

In some embodiments, the fiber cement composite formulation comprises between 35% and 50% by dry weight of the cementitious binder. In some embodiments, the cementitious binder comprises between 5% and 20% by dry weight of limestone. In some embodiments, the fiber cement composite formulation further comprises a viscosity-enhancing admixture. In some embodiments, the fiber cement composite formulation comprises between 0.5% and 2% by dry weight of the viscosity-enhancing admixture. In some embodiments, the viscosity-enhancing admixture comprises at least one of hydroxyethyl methyl cellulose, hydroxypropyl methyl cellulose, and hydroxyethyl cellulose. In some embodiments, said viscosity-enhancing admixture comprises a viscosity between 1,000 mPa·s and 100,000 mPa·s in a 2% water solution. In some embodiments, said viscosity is between 50,000 mPa·s and 100,000 mPa·s in the 2% water solution. In some embodiments, the fiber cement composite formulation further comprises an air-entraining admixture. In some embodiments, the fiber cement composite formulation comprises between 0.01% and 0.5% by dry weight of the air-entraining admixture. In some embodiments, the fiber cement composite formulation comprises between 0.03% and 0.07% by dry weight of the air-entraining admixture. In some embodiments, the ratio of the cementitious binder to the silica in the fiber cement composite formulation is between 1 and 1.4. In some embodiments, the fiber cement composite formulation comprises between 3% and 5% by dry weight of the cellulose fibers. In some embodiments, the fiber cement composite formulation comprises between 0.5% and 2% by dry weight of the polypropylene fibers. In some embodiments, the fiber cement composite formulation further comprises between 5% and 30% by dry weight of microparticulate cured fiber cement material.

### BRIEF DESCRIPTION OF THE DRAWINGS

Certain embodiments of the present disclosure will now be described, by way of example only, with reference to the accompanying drawings.

FIGS. 1-2 illustrate an example microstructure of foamed fiber cement in accordance with aspects of this disclosure.

FIG. 3 illustrates an example method of manufacturing a fiber cement product in accordance with aspects of this disclosure.

### DETAILED DESCRIPTION

Disclosed herein are fiber cement composite formulations that have a significantly reduced carbon footprint in comparison to existing formulations. Existing fiber cement formulations utilize Portland cement (such as Type 1 Portland cement) as a cementitious binder. Production of cement clinker, a key constituent of such cementitious binders, results in considerable carbon emissions. In contrast to such existing fiber cement formulations, various embodiments of disclosed formulations include cementitious binders having a notable percentage of limestone (for example, between about 5% and about 15%) which replaces the amount of cement clinker needed and thus reduces the amount of carbon emissions generated from the manufacture of fiber cement products (for example, fiber cement building articles). In addition to the environmental benefits, the disclosed fiber cement composite formulations include synergistic combinations of more environmentally friendly cementitious binders, silica, and fibers (such as cellulose and polypropylene fibers) which yield unexpectedly high strength, durability, and dimensional stability characteristics in cured fiber cement products. For example, the disclosed fiber cement composite formulations exhibit unexpectedly high modulus of rupture (MOR) in comparison to existing fiber cement formulations that utilize conventional Portland cement for the cementitious binder. The disclosed fiber cement composite formulations also exhibit moisture movement characteristics that are similar to those exhibited in existing fiber cement formulations that utilize conventional Portland cement for the cementitious binder.

Various embodiments of the disclosed fiber cement composite formulations additionally include microparticulate cured fiber cement material. Inclusion of such microparticulate cured fiber cement material advantageously accelerates initial hydration of the fiber cement composite formulation prior to final curing (for example, via an autoclave) so that desired hardness and hydration phases result, which is important for achieving robust mechanical properties and performance of the cured fiber cement product. Various embodiments of the fiber cement composite formulations disclosed herein include one or more viscosity-enhancing admixtures for facilitating the manufacturing of fiber cement products via the extrusion process. Various embodiments of the fiber cement composite formulations disclosed herein include one or more air-entrainment agents for introducing voids in the finished fiber cement products which, among other things, increases workability of the formulation and reduces density and weight of the cured fiber cement products. The disclosed fiber cement composite formulations have been found to be particularly suitable for manufacturing fiber cement products via an extrusion process.

Embodiments of fiber cement composite formulations disclosed herein generally include a cementitious binder, silica, and fibers. In contrast to typical cementitious binders used in conventional fiber cement formulations (such as Type 1 Portland cement), various embodiments of the cementitious binders disclosed herein include limestone as a partial replacement for traditional cement clinker. Disclosed cementitious binders generally include cement and limestone. For example, the cementitious binders can include at least about 1%, at least about 2%, at least about 5%, at least about 10%, at least about 15%, or at least about 20% by dry weight of limestone. As another example, the cementitious binders can include between about 5% and about 40%, between about 5% and about 30%, between about 5% and about 20%, between about 5% and about 15%, between about 5% and about 10%, between about 5% and about 15%, or between about 10% and about 20% by dry weight of limestone, or any value or range within or bounded by any of these ranges or values. In some embodiments, the cementitious binder includes dolomite.

In some embodiments, the cementitious binder has a particle size distribution that is between about 1 μm and about 500 μm, for example, between about 1 μm and about 450 μm, between about 1 μm and about 400 μm, between about 1 μm and about 350 μm, between about 1 μm and about 300 μm, between about 1 μm and about 250 μm, between about 1 μm and about 200 μm, between about 1 μm and about 150 μm, or between about 1 μm and about 100 μm, or any value or range within or bounded by any of these ranges or values. In some embodiments, the particle size distribution is less than about 400 μm, less than about 350 μm, less than about 300 μm, less than about 250 μm, less than about 200 μm, less than about 150 μm, less than about 100 μm, or less than about 50 μm.

In some embodiments, the cementitious binder has a mean particle size that is between about 1 μm and about 50 μm, for example, between about 5 μm and about 45 μm, between about 10 μm and about 40 μm, between about 15 μm and about 35 μm, between about 20 μm and about 30 μm, or between about 15 μm and about 25 μm, or any value or range within or bounded by any of these ranges or values.

In some embodiments, the cementitious binder has a median particle size that is between about 1 μm and about 50 μm, for example, between about 5 μm and about 45 μm, between about 10 μm and about 40 μm, between about 15 μm and about 35 μm, between about 20 μm and about 30 μm, between about 15 μm and about 20 μm, or between about 10 μm and about 20 μm, or any value or range within or bounded by any of these ranges or values.

In some embodiments, the fiber cement composite formulation comprises between about 10% and about 70% by dry weight of cementitious binder, for example, between about 15% and about 65%, between about 20% and about 60%, between about 25% and about 55%, between about 30% and about 50%, between about 35% and about 45%, or between about 30% and about 60% by dry weight of cementitious binder, or any value or range within or bounded by any of these ranges or values. In some embodiments, the fiber cement composite formulation comprises no more than about 60%, no more than about 55%, no more than about 50%, no more than about 45%, no more than about 40%, no more than about 35%, or no more than about 30% by dry weight of cementitious binder.

The fiber cement composite formulations disclosed herein can include cellulose fibers, such as unrefined/unfibrillated and/or refined/fibrillated cellulose pulps from various sources, including but not limited to bleached, unbleached, semi-bleached cellulose pulp. The cellulose pulp can be made of softwood, hardwood, agricultural raw materials, recycled waste paper or any other forms of lignocellulosic materials. The fiber cement composite formulations disclosed herein can additionally or alternatively include synthetic fibers, such as polypropylene fibers. The fiber cement composite formulations can include a blend of one or more types of fibers, for example, a blend of cellulose pulp fibers and polypropylene fibers. In some embodiments, the amount of cellulose pulp fibers in the blend is higher than the amount of polypropylene fibers. In some embodiments, the ratio between cellulose pulp fibers and polypropylene fibers is between about 0.5 and about 5, for example, between about 1 and about 4, between about 2 and about 3, between about 1 and about 3, or between about 2.5 and about 3.5, or any value or range within or bounded by any of these ranges or values. In some embodiments, the ratio between cellulose pulp fibers and polypropylene fibers is at least about 1.5, at least about 2, at least about 2.5, or at least about 3.

In some embodiments, the fiber cement composite formulation comprises between about 0.5% and about 10% by dry weight of cellulose pulp fibers, for example, between about 1% and about 9%, between about 2% and about 8%, between about 3% and about 7%, between about 4% and about 6%, between about 2% and about 6%, or between about 3% and about 5% by dry weight of cellulose pulp fibers, or any value or range within or bounded by any of these ranges or values. In some embodiments, the fiber cement composite formulation comprises between about 0.2% and about 5% by weight of polypropylene fibers, for example, between about 0.5% and about 4.5%, between about 1% and about 4%, between about 1.5% and about 3.5%, between about 2% and about 3%, between about 1% and about 4%, between about 2% and about 3%, between about 0.5% and about 4%, between about 0.5% and about 3%, between about 0.5% and about 2%, or between about 1% and about 2%, or any value or range within or bounded by any of these ranges or values.

The fiber cement composite formulations disclosed herein can include silica. Such silica can have a particle size distribution that is between about 1 μm and about 300 μm, for example, between about 1 μm and about 250 μm, between about 1 μm and about 200 μm, between about 1 μm and about 150 μm, between about 1 μm and about 100 μm, or between about 1 μm and about 50 μm, or any value or range within or bounded by any of these ranges or values. In some embodiments, the silica has particle size distribution that is less than about 300 μm, less than about 250 μm, less than about 200 μm, less than about 150 μm, less than about 100 μm, or less than about 50 μm.

In some embodiments, the silica has a mean particle size that is between about 1 μm and about 50 μm, for example, between about 5 μm and about 45 μm, between about 10 μm and about 40 μm, between about 15 μm and about 35 μm, between about 20 μm and about 30 μm, or between about 30 μm and about 40 μm, or any value or range within or bounded by any of these ranges or values.

In some embodiments, the silica has a median particle size that is between about 1 μm and about 50 μm, for example, between about 5 μm and about 45 μm, between about 10 μm and about 40 μm, between about 15 μm and about 35 μm, between about 20 μm and about 30 μm, between about 15 μm and about 25 μm, or between about 10 μm and about 25 μm, or any value or range within or bounded by any of these ranges or values.

In some embodiments, the fiber cement composite formulation comprises between about 10% and about 60% by dry weight of silica, for example, between about 15% and about 55%, between about 20% and about 50%, between about 25% and about 45%, between about 30% and about 40%, between about 30% and about 45%, between about 35% and about 45%, between about 35% and about 40%, between about 30% and about 50%, or between about 30% and about 60% by dry weight of silica, or any value or range within or bounded by any of these ranges or values. In some embodiments, the fiber cement composite formulation comprises no more than about 60%, no more than about 55%, no more than about 50%, no more than about 45%, no more than about 40%, no more than about 35%, or no more than about 30% by dry weight of silica.

In some embodiments of the disclosed fiber cement composite formulations, a ratio between the cementitious binder (which can be any of those described herein) and silica is between about 0.5 and about 3, for example, between about 1 and about 2.5, between about 1 and about 2, between about 1.5 and about 2, between about 1.1 and about 1.7, between about 0.6 and about 2, between about 0.7 and about 1.9, between about 0.8 and about 1.8, between about 0.9 and about 1.7, between about 1 and about 1.6, between about 1.1 and about 1.5, or between about 1.2 and about 1.4, or any value or range within or bounded by any of these ranges or values.

In addition to the above-mentioned materials, the disclosed fiber cement composite formulations can include microparticulate cured fiber cement material. The microparticulate cured fiber cement material may include particles derived from grinding, crushing, sanding, and/or machining of manufactured fiber cement products. Such microparticulate cured fiber cement material advantageously accelerates initial hydration of the fiber cement composite formulation prior to final curing (for example, via an autoclave) so that desired hardness and hydration phases result, which is important for achieving robust mechanical properties and performance of the cured fiber cement product. The microparticulate cured fiber cement material can comprise silica, among other components. The microparticulate cured fiber cement material can comprise between about 2% and about 30% of silica by dry weight. For example, the microparticulate cured fiber cement material can comprise between about 5% and about 25%, between about 10% and about 20%, between about 15% and about 25%, or between about 15% and about 20%, of silica by dry weight, or any value or range within or bounded by any of these ranges or values. In some embodiments, a moisture content of the microparticulate cured fiber cement material (prior to being combined with other components of the fiber cement composite formulation) is between about 5% and about 30%, for example, between about 10% and about 25%, between about 15% and about 20%, or between about 10% and about 20%, or any value or range within or bounded by any of these ranges or values.

The microparticulate cured fiber cement material can have a particle size distribution that is between about 1 μm and about 700 μm, for example, between about 1 μm and about 650 μm, between about 1 μm and about 600 μm, between about 1 μm and about 550 μm, or between about 1 μm and about 500 μm, or any value or range within or bounded by any of these ranges or values. In some embodiments, the microparticulate cured fiber cement material has particle size distribution that is less than about 700 μm, less than about 650 μm, less than about 600 μm, less than about 550 μm, or less than about 500 μm.

In some embodiments, the microparticulate cured fiber cement material has a median particle size that is between about 1 μm and about 50 μm, for example, between about 5 μm and about 45 μm, between about 10 μm and about 40 μm, between about 15 μm and about 35 μm, between about 20 μm and about 30 μm, or between about 25 μm and about 35 μm, or any value or range within or bounded by any of these ranges or values.

In some embodiments, the fiber cement composite formulation comprises between about 5% and about 30% by dry weight of microparticulate cured fiber cement material, for example, between about 10% and about 25%, between about 15% and about 20%, between about 5% and about 15%, between about 15% and about 25%, or between about 20% and about 25% by dry weight of microparticulate cured fiber cement material, or any value or range within or bounded by any of these ranges or values. In some embodiments, the fiber cement composite formulation comprises at least about 1% by dry weight of microparticulate cured fiber cement material, for example, at least about 5%, at least about 10%, at least about 15%, at least about 20%, or at least about 25% by dry weight of microparticulate cured fiber cement material.

As mentioned above, embodiments of fiber cement composite formulations disclosed herein can include silica. The silica can be included as part of the formulation in a batch form (for example, as a ground silica sand) and can have any of the characteristics discussed previously (for example, particle size distribution, mean and median particle size). As also mentioned above, some embodiments of the disclosed formulations include microparticulate cured fiber cement material, which can include silica, among other components. In such embodiments, the fiber cement composite formulation includes a first quantity silica (in batch form) and a second quantity of silica that is part of the microparticulate cured fiber cement material. In some embodiments, the fiber cement composite formulation comprises between about 10% and about 60% by dry weight of such first quantity of silica, for example, between about 15% and about 55%, between about 20% and about 50%, between about 20% and about 45%, between about 25% and about 45%, between about 25% and about 40%, between about 30% and about 35%, or between about 35% and 40% by dry weight of such first quantity of silica, or any value or range within or bounded by any of these ranges or values. The fiber cement composite formulation can comprise between about 0.5% and about 10% by dry weight of such second quantity of silica, for example, between about 1% and about 9%, between about 2% and about 8%, between about 3% and about 7%, between about 4% and about 6%, between about 1.5% and about 2.5%, or between about 4% and about 5% by dry weight of such second quantity of silica, or any value or range within or bounded by any of these ranges or values.

In some embodiments, a total amount of silica in the fiber cement composite formulation (which can include both of the above-described first and second quantities of silica) comprises between about 10% and about 60% by dry weight of the fiber cement composite formulation, for example, between about 15% and about 55%, between about 20% and about 50%, between about 25% and about 45%, between about 30% and about 40%, between about 30% and about 45%, between about 35% and about 45%, between about 35% and about 40%, between about 30% and about 50%, or between about 25% and about 50% by dry weight of the fiber cement composite formulation, or any value or range within or bounded by any of these ranges or values. In some embodiments, the total amount of silica in the fiber cement composite formulation comprises no more than about 60%, no more than about 55%, no more than about 50%, no more than about 45%, no more than about 40%, no more than about 35%, or no more than about 30% by dry weight of the fiber cement composite formulation.

In some embodiments, a ratio between the cementitious binder and the total amount of silica in the fiber cement composite formulation is between about 0.5 and about 2, for example, between about 0.9 and about 2, between about 1 and about 1.9, between about 1.1 and about 1.8, between about 1.2 and about 1.7, between about 1.3 and about 1.5, between about 0.9 and about 1.7, between about 0.7 and about 1.7, between about 0.8 and about 1.5, between about 0.9 and about 1.5, between about 1 and about 1.4, or between about 1 and about 1.3. As discussed previously, the cementitious binders disclosed herein can include cement and limestone. For example, about 5% or more of the dry weight of the cementitious binder can be limestone. In some embodiments, a ratio between the amount of cement in the fiber cement composite formulation and the total amount of silica in the fiber cement composite formulation is between about 0.5 and about 1.5, between about 0.6 and about 1.4, between about 0.7 and about 1.3, between about 0.8 and about 1.2, between about 0.9 and about 1.1, between about 0.7 and about 1.5, or between about 0.9 and about 1.3. Advantageously, fiber cement composite products manufactured via extrusion from formulations including such proportions of cementitious binder, cement, and total silica exhibit unexpectedly high strength and durability characteristics, including but not limited to high modulus of rupture and low moisture movement.

The fiber cement composite formulations disclosed herein can include one or more viscosity-enhancing agents (VEAs). Inclusion of VEA(s) can enhance the cohesion and stability of the formulations, and can act as a thickener, binder, water-retention agent, surfactant, and/or lubricant. Inclusion of VEA(s) can aid in the mixing and/or forming processes during manufacturing of a fiber cement product. VEAs can also lower pressures during an extrusion manufacturing process. The fiber cement composite formulations disclosed herein can include one or more VEA(s) such as hydroxyethyl methyl cellulose, hydroxypropyl methyl cellulose, and/or hydroxyethyl cellulose. In some embodiments, the VEA has a viscosity ranging from 1,000 mPa·s to 100,000 mPa·s in a 2% water solution, for example from 50,000 mPa·s to 100,000 mPa·s in a 2% water solution.

The fiber cement composite formulations disclosed herein can comprise between about 0.1% and about 2% by dry weight of VEA(s), for example, between about 0.2% and about 1.9%, between about 0.3% and about 1.8%, between about 0.4% and about 1.7%, between about 0.5% and about 1.6%, between about 0.6% and about 1.5%, between about 0.7% and about 1.4%, between about 0.8% and about 1.3%, between about 0.9% and about 1.2%, between about 1% and about 1.1%, between about 0.5% and about 1%, between about 0.6% and about 1%, between about 0.7% and about 1%, or between about 0.7% and about 0.8% by dry weight of VEA(s), or any value or range within or bounded by any of these ranges or values. In some embodiments, the fiber cement composite formulation includes no more than about 3%, no more than about 2.5%, no more than about 2%, no more than about 1.5%, or no more than about 1% by weight of VEA(s).

The fiber cement composite formulations disclosed herein can include one or more air entrainment agents (AEAs). Inclusion of AEA(s) in the formulation during the manufacturing process can increase workability of the formulation and entrain air (for example, introduce voids) within the matrix of the produced fiber cement product (for example, fiber cement trim), thereby lowering the weight and density of the product. AEAs are particularly applicable where such fiber cement composite formulations are formed into fiber cement products via extrusion, where the formulations are forced through an extruder machine and through a die. AEAs can be wood resin based, protein based, cationic, anionic, and non-ionic. Some embodiments of the fiber cement composite formulations disclosed herein include one or more AEAs that are protein and/or synthetic based. The fiber cement composite formulations disclosed herein can include AEAs such as sodium dodecyl sulfate and/or sodium lauryl sulfate. Other example AEAs are CMXTM Foam Concentrate (manufactured by Richway Industries), AERLITE-iX (manufactured by Aerix Industries), and MasterCell® 30 (manufactured by Master Builders Solutions), and TR-A, TR-B, TR-C (manufactured by Turnnano).

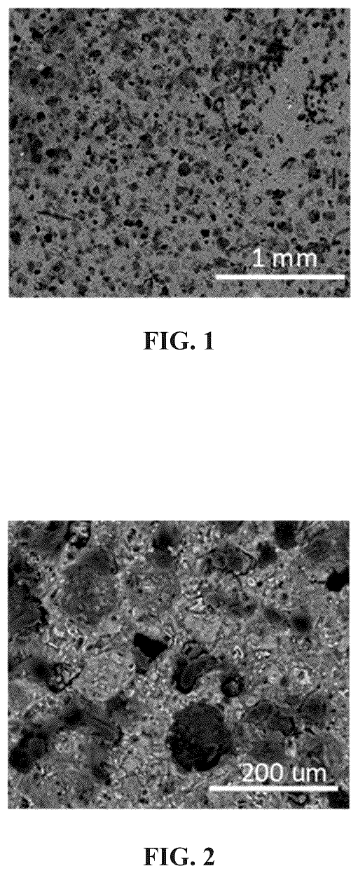

The fiber cement composite formulations disclosed herein can include an entrained gas content between about 0% and about 30%, for example, between about 5% and about 25%, between about 10% and about 20%, or between about 5% and about 15%. Entrained gas can be air, nitrogen, carbon dioxide, or a mix of one or more of these. The typical microstructure of foamed fiber cement is illustrated in FIGS. 1-2. FIG. 1 illustrates a scanning electron microscope (SEM) photograph of the example foamed fiber cement microstructure at 1 mm scale and FIG. 2 illustrates an SEM photograph of the example foamed fiber cement microstructure at 200 micron (μm) scale. Size of bubbles can vary in size, for example, between about 0.02 mm to about 2 mm.

The fiber cement composite formulations disclosed herein can comprise between about 0.01% and about 1% by dry weight of AEA(s), for example, between about 0.02% and about 0.9%, between about 0.03% and about 0.8%, between about 0.04% and about 0.7%, between about 0.05% and about 0.6%, between about 0.06% and about 0.5%, between about 0.07% and about 0.4%, between about 0.08% and about 0.3%, between about 0.09% and about 0.2%, between about 0.01% and about 0.1%, between about 0.04% and about 0.1%, between about 0.04% and about 0.06%, or between about 0.02% and about 0.2% by dry weight of AEA(s), or any value or range within or bounded by any of these ranges or values. In some embodiments, the fiber cement composite formulation includes no more than about 1%, no more than about 0.09%, no more than about 0.08%, no more than about 0.07%, no more than about 0.06%, or no more than about 0.05% by dry weight of AEA(s).

Introduction of gas bubbles into the fiber cement composite formulation can be achieved through various methods. When manufacturing with an extruder, AEA(s) can be added into a solution that is inserted into a barrel of the extruder that contains the other components of the fiber cement composite formulation, such as cementitious binder, silica, microparticulate cured fiber cement material, VEA(s), cellulose fibers, and/or polypropylene fibers, any or all of which can be referred to collectively as a “cementitious paste” or “base mix”. In such cases, the mixing processes in the extruder can generate mechanical force which can create foam and therefore voids in the paste. Another approach when manufacturing with an extruder is to generate foam outside the extruder via an aqueous solution with the AEA. In such case, the pre-generated foam can be inserted into the extruder to join the other components of the cementitious paste.

### Manufacturing Methods

Components of the fiber cement composite formulations disclosed herein may be mixed in a slurry form including water, and may be formed into fiber cement products by an extrusion process. Such extrusion process can include forcing the fiber cement composite formulations (for example, in slurry form) to flow through an extruder and out of a die. Water content may be removed from the extruded fiber cement products by various curing methods including autoclaving or the like, to form solid, cured fiber cement products. The fiber cement products can be precured prior to autoclaving, for example, for a time period of between 0 and 10 hours which can be at a lower temperature than the temperature used for the autoclave curing process. Cured fiber cement products manufactured from the formulations disclosed herein can be used as interior and/or exterior building articles. One non-limiting example of such a fiber cement product is a fiber cement trim suitable for use as a finishing material for the interior and/or exterior of a building, for example, for surrounding the openings in a building (such as window and door openings).

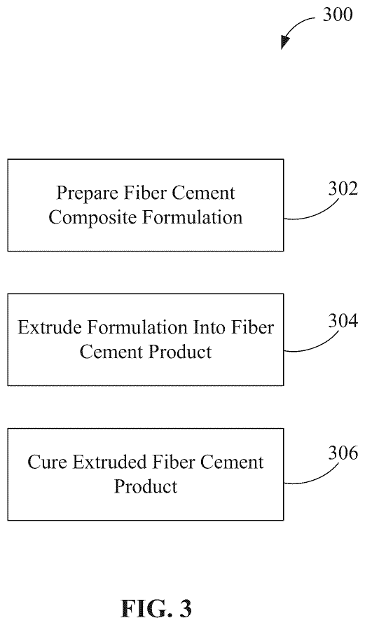

FIG. 3 illustrates an example method 300 of manufacturing a fiber cement product (for example, fiber cement trim) via an extrusion process. At step 302, the fiber cement composite formulation is prepared. The fiber cement composite formulation can include any of the components described herein. For example, the fiber cement formulation can include any of the cementitious binders, silica, fibers, VEAs, microparticulate cured fiber cement material, and/or AEAs disclosed herein.

Preparation of the fiber cement formulation at step 302 can involve combining these components in a variety of ways. Generally, the components are mixed together with water to form a slurry that is extruded from an extruder (at step 304). As discussed elsewhere herein, AEAs can be utilized to introduce foam into the fiber cement formulation. AEAs can be mixed with other components of the fiber cement composite formulation (such as the cementitious binder, silica, fibers, microparticulate cured fiber cement material, and/or VEA(s)) as described elsewhere herein.

At step 304, the fiber cement formulation (which may be foamed via the methods described above with respect to utilization of the AEA) is extruded to form a green (uncured) fiber cement product. At step 306, the extruded fiber cement product is cured. Step 206 can include autoclave curing the fiber cement product in a steam pressurized vessel at a temperature that is between about 120° C. and about 200° C., for example, between about 130° C. and about 190° C., between about 140° C. and about 180° C., between about 150° C. and about 170° C., or between about 150° C. and about 160° C., or any value or range within or bounded by any of these ranges or values (for example, about 120° C., about 130°C., about 140° C., about 150° C., about 160°C., about 170° C., about 180° C., about 190°C., or about 200° C.). Step 206 can include autoclave curing (at any of the above-described temperatures) for a time period of between about 4 hours and about 24 hours, for example, between about 5 hours and about 20 hours, between about 6 hours and about 19 hours, between about 7 hours and about 18 hours, between about 8 hours and about 17 hours, between about 9 hours and about 16 hours, between about 10 hours and about 15 hours, between about 11 hours and about 14 hours, between about 12 hours and about 13 hours, between about 8 hours and about 14 hours, between about 6 hours and about 16 hours, or between about 10 hours and about 14 hours, or any value or range within or bounded by any of these ranges or values (for example, about 4 hours, about 6 hours, about 8 hours, about 10 hours, about 12 hours, about 14 hours, about 16 hours, about 18 hours, about 20 hours, or about 22 hours).

Step 306 can additionally include precuring the fiber cement product prior to autoclave curing. Such precuring can include placing the fiber cement product in a vessel at a temperature that is different (for example, lower) than a temperature used for the autoclave curing process. For example, such precuring can include subjecting the fiber cement product to a temperature of between about 20° F. and about 150° F., for example, between about 30° F. and about 140° F., between about 40° F. and about 130° F., between about 50° F. and about 120° F., between about 60° F. and about 110° F, between about 70° F. and about 100° F., between about 80° F. and about 90° F, between about 50° F. and about 140° F., between about 60° F. and about 130° F., between about 70° F. and about 120° F., between about 80° F. and about 110° F., between about 90° F. and about 100° F., or between about 40° F. and about 120° F., or any value or range within or bounded by any of these ranges or values (for example, about 30° F., about 40° F., about 50° F., about 60° F., about 70° F., about 80° F., about 90° F., about 100° F., about 110° F., about 120° F., about 130° F., about 140° F., or about 150° F.). In some embodiments, such precuring can include subjecting the fiber cement product to a temperature that is less than about 200° F., less than about 190° F., less than about 180° F., less than about 170° F., less than about 160° F., less than about 150° F., less than about 140° F., less than about 130° F., less than about 120° F., less than about 110° F., less than about 100° F., less than about 90° F., less than about 80° F., less than about 70° F., less than about 60° F., less than about 50° F., or less than about 40° F., or any value or range within or bounded by any of these ranges or values. Precuring can include subjecting the fiber cement product to any of the above-described temperatures for a time period of between about 4 hours and about 24 hours, for example, between about 5 hours and about 20 hours, between about 6 hours and about 19 hours, between about 7 hours and about 18 hours, between about 8 hours and about 17 hours, between about 9 hours and about 16 hours, between about 10 hours and about 15 hours, between about 11 hours and about 14 hours, between about 12 hours and about 13 hours, between about 4 hours and about 10 hours, or between about 6 hours and about 8 hours, or any value or range within or bounded by any of these ranges or values (for example, about 4 hours, about 6 hours, about 8 hours, about 10 hours, about 12 hours, about 14 hours, about 16 hours, about 18 hours, about 20 hours, or about 22 hours). In some embodiments, the time period that the fiber cement product is precured is less than a time period in which the fiber cement product is autoclave cured.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally” and “substantially” may refer to an amount that is within less than or equal to 10% of, within less than or equal to 5% of, or within less than or equal to 1% of the stated value, amount, or characteristic.

Although making and using various embodiments are discussed in detail below, it should be appreciated that the description provides many inventive concepts that may be embodied in a wide variety of contexts. The specific aspects and embodiments discussed herein are merely illustrative of ways to make and use the systems and methods disclosed herein and do not limit the scope of the disclosure. The systems and methods described herein may be used for formulation of cementitious and/or fiber cement building articles and are described herein with reference to this application. However, it will be appreciated that the disclosure is not limited to this particular field of use.

1. A fiber cement composite formulation comprising:
between 30% and 60% by dry weight of a cementitious binder having a particle size distribution between 1 μm and 150 μm, the cementitious binder comprising cement and at least 5% by dry weight of limestone;
a first quantity of silica having a particle size distribution between 1 μm and 250 μm;
between 5% and 30% by dry weight of microparticulate cured fiber cement material having a particle size distribution between 1 μm and 600 μm, said microparticulate cured fiber cement material comprising a second quantity of silica, wherein a total amount of silica in the fiber cement composite formulation that includes the first and second quantities of silica comprises between 20% and 50% of the dry weight of the fiber cement composite formulation, and wherein a ratio of the cement to the total amount of silica in the fiber cement composite formulation is between 0.7 and 1.5;
between 0.5% and 10% by dry weight of cellulose fibers;
between 0.2% and 4% by dry weight of polypropylene fibers;
a viscosity-enhancing admixture; and
an air-entraining admixture.

2. (canceled)

3. The fiber cement composite formulation of claim 1, wherein the cementitious binder comprises between 5% and 20% by dry weight of limestone.

4. (canceled)

5. (canceled)

6. (canceled)

7. (canceled)

8. (canceled)

9. (canceled)

10. The fiber cement composite formulation of claim 1, wherein the fiber cement composite formulation comprises between 0.5% and 2% by dry weight of the viscosity-enhancing admixture.

11. The fiber cement composite formulation of claim 1, wherein the viscosity-enhancing admixture comprises hydroxyethyl methyl cellulose.

12. (canceled)

13. (canceled)

14. The fiber cement composite formulation of claim 1, wherein the fiber cement composite formulation comprises between 0.01% and 0.5% by dry weight of the air-entraining admixture

15. (canceled)

16. The fiber cement composite formulation of claim 1, wherein the first quantity of silica has a mean particle size that is between 10 μm and 40 μm.

17. (canceled)

18. The fiber cement composite formulation of claim 1, wherein the second quantity of silica comprises between 15% and 25% of the dry weight of said microparticulate cured fiber cement material.

19. (canceled)

20. A method of manufacturing a fiber cement building article, the method comprising:
forming the fiber cement building article from a fiber cement composite formulation using an extruder, said fiber cement composite formulation comprising:
between 30% and 60% by dry weight of a cementitious binder having a particle size distribution between 1 μm and 150 μm, the cementitious binder comprising cement and at least 5% by dry weight of limestone and;
a first quantity of silica having a particle size distribution between 1 μm and 250 μm;
between 5% and 30% by dry weight of microparticulate cured fiber cement material having a particle size distribution between 1 μm and 600 μm, said microparticulate cured fiber cement material comprising a second quantity of silica, wherein a total amount of silica in the fiber cement composite formulation that includes the first and second quantities of silica comprises between 20% and 50% of the dry weight of the fiber cement composite formulation, and wherein a ratio of the cement to the total amount of silica in the fiber cement composite formulation is between 0.7 and 1.5;
between 0.5% and 10% by dry weight of cellulose fibers;
between 0.2% and 4% by dry weight of polypropylene fibers;
a viscosity-enhancing admixture;
an air-entraining admixture; and
curing the fiber cement building article.

21. The method of claim 20, wherein said curing comprises autoclave curing the fiber cement building article in an autoclave.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. A fiber cement composite formulation comprising:
between 30% and 60% by dry weight of a cementitious binder having a particle size distribution between 1 μm and 150 μm, the cementitious binder comprising cement and at least 5% by dry weight of limestone;
between 20% and 50% by dry weight of silica, wherein a ratio of the cement to the silica in the fiber cement composite formulation is between 0.7 and 1.5;
between 0.5% and 10% by dry weight of cellulose fibers; and
between 0.2% and 4% by dry weight of polypropylene fibers.

38. (canceled)

39. The fiber cement composite formulation of claim 37, wherein the cementitious binder comprises between 5% and 20% by dry weight of limestone.

40. The fiber cement composite formulation of 37, further comprising a viscosity-enhancing admixture.

41. The fiber cement composite formulation of claim 40, wherein the fiber cement composite formulation comprises between 0.5% and 2% by dry weight of the viscosity-enhancing admixture.

42. The fiber cement composite formulation of Claim 40, wherein the viscosity-enhancing admixture comprises of hydroxyethyl methyl cellulose.

43. The fiber cement composite formulation of claim 40, wherein said viscosity-enhancing admixture comprises a viscosity between 1,000 mPa·s and 100,000 mPa·s in a 2% water solution.

44. (canceled)

45. (canceled)

46. (canceled)

47. The fiber cement composite formulation of claim 37, wherein the fiber cement composite formulation comprises between 0.03% and 0.07% by dry weight of an air-entraining admixture.

48. The fiber cement composite formulation of 37, wherein the ratio of the cement to the silica in the fiber cement composite formulation is between 0.9 and 1.3.

49. The fiber cement composite formulation of claim 37, wherein the fiber cement composite formulation comprises between 3% and 5% by dry weight of the cellulose fibers.

50. The fiber cement composite formulation of claim 37, wherein the fiber cement composite formulation comprises between 0.5% and 2% by dry weight of the polypropylene fibers.

51. The fiber cement composite formulation of claim 37, wherein the fiber cement composite formulation further comprises between 5% and 30% by dry weight of microparticulate cured fiber cement material.
